(19) United States
(12) Patent Application Publication
(10) Pub. No.: US 2003/0025920 A1
(43) Pub. Date: Feb. 6, 2003

(54) Printable media for use in multi-sheet assemblies

(75) Inventor: Norman Yamamoto, Yorba Linda, CA (US)

Correspondence Address: HENRICKS SLAVIN AND HOLMES LLP, SUITE 200, 840 APOLLO STREET, EL SEGUNDO, CA, 90245

(73) Assignee: Avery Dennison Corporation

(21) Appl. No.: 09/920,236

(22) Filed: Jul. 31, 2001

(51) Int. Cl. G06K 1/00; G06F 15/00

(52) U.S. Cl. 358/1.2; 358/1.18

(57) ABSTRACT

Printable media including a sheet, at least one strip of adhesive material on the sheet adjacent to a one of the side edges, and a plurality of liners positioned over the at least one strip of adhesive material.

### BACKGROUND OF THE INVENTIONS

1. Field of Inventions

The present inventions relate generally to printable media and, more particularly, to printable media that may be used in multi-sheet assemblies.

2. Description of the Related Art

Conventional home and office printing devices, such as laser and inkjet printers, are typically configured to print images including text and/or graphics onto 8½ inch (letter size) and 8½×14 inch (legal size) sheets of paper and other printable media in both portrait and landscape modes. There are however many instances, such as banners, organizational charts and large spread sheet printouts, where the desired image is too large to fit on a single sheet. Here, a number of individual sheets containing respective portions of the overall image must be secured to one another to form a multi-sheet assembly that displays the desired image.

Current banner software programs, for example, may be used to sequentially print portions of large text and/or graphic images onto individual sheets. A banner that will ultimately consist of three sheets is typically printed as follows. The first sheet is printed with four margins, while the second and third sheets are printed with three margins. Portions of the overall image are printed, if necessary, in what would have been the fourth margins of the second and third sheets, which are the margins near the trailing edges of the sheets. The material printed near the trailing edge of the second sheet is duplicative of the material near the leading edge margin of the first sheet and the material printed near the trailing edge of the third sheet is duplicative of the material near the leading edge margin of the second sheet. The banner is assembled by placing the trailing edge portion of the second sheet over the leading edge portion of the first sheet and the trailing edge portion of the third sheet over the leading edge portion of the second sheet such that the image portions on the sheets register with one another to form a continuous image.

The banner is then turned over so that the back sides of the sheets can be taped together to complete the banner. Taping sheets together in this manner can, however, be difficult and inconvenient. It also increases the likelihood that the images will not be properly registered.

More recently, printable media has been proposed which includes a sheet, a strip of pressure sensitive adhesive located inwardly from one of the side edges of the sheet, and a release liner covering the strip of pressure sensitive adhesive. A line of perforations separates the strip of pressure sensitive adhesive and the side edge. The area between the perforations and the side edge corresponds to an expected margin area which may be removed during assembly. The inventor herein has determined that there are a number of shortcomings associated with the proposed printable media. For example, the proposed printable media does not allow users to vary the width of the adhesive strip, which is problematic given the fact that software programs produce margins of varying size.

There are also other issues associated with the proposed printable media. Conventional software programs produce multi-sheet assemblies that are one-dimensional (i.e. they extend in a single direction). A typical banner program, for example, produces banners by sequentially printing images on a number of sheets in landscape mode. The sheets are connected to one another end to end to form a banner that extends horizontally. While the length of the banner will be determined by the number of sheets, the height is limited to 8½ inches. The image itself will typically be slightly smaller due to the margins. Alternatively, the banner image can be printed in portrait mode and the sheets connected to one another side to side to form banner that is 11 inches high (or 14 inches where legal sized paper is used).

The inventor herein has determined that it would be desirable if software programs were available that produce two-dimensional multi-sheet assemblies (i.e. assemblies that extend in two directions). A four sheet assembly, for example, could include two upper sheets and two lower sheets. The ability to “grow” the assembly in two directions would eliminate the restrictions on image size. The inventor herein has also determined that the aforementioned proposed printable media, which includes a single adhesive strip that is associated with one of the side edges, would be less than optimal for two-dimensional multi-sheet assemblies. A sheet of such printable media would not, for example, be able to secure itself to both a sheet above and a sheet to the side in a two-dimensional multi-sheet assembly.

### SUMMARY OF THE INVENTIONS

Accordingly, one object of the present inventions is to provide printable media that solves, for practical purposed, at least one of the aforementioned problems in the art. Another object of the present inventions is to provide printable media with an adhesive area that can be readily varied in size. Still another object of the present inventions is to provide printable media that is well suited for use in two-dimensional multi-sheet assemblies.

In order to accomplish some of these and other objectives, printable media in accordance with one example of a present invention includes a sheet, at least one strip of adhesive material on the sheet adjacent to a one of the side edges, and a plurality of liners positioned over the at least one strip of adhesive material. There are a number of advantages associated with such printable media. For example, the user can selectively determine the size of the overall adhesive area by simply removing the appropriate number of liners. More specifically, the removal of two of the liners will result in a larger overall adhesive area then will the removal of one of the liners. Such flexibility allows the user to more precisely match the width of the adhesive area to that required by the particular application.

In order to accomplish some of these and other objectives, printable media in accordance with one example of a present invention includes a sheet, a first strip of adhesive material adjacent to a first side edge, and a second strip of adhesive material adjacent to a second side edge that shares a common corner with the first side edge. There are a number of advantages associated with such printable media. For example, the first and second edges of such printable media may be secured to other sheets, thereby enabling the formation of two-dimensional multi-sheet assemblies.

The above described and many other features and attendant advantages of the present inventions will become apparent as the inventions become better understood by reference to the following detailed description when considered in conjunction with the accompanying drawings.

### BRIEF DESCRIPTION OF THE DRAWINGS

Detailed description of preferred embodiments of the inventions will be made with reference to the accompanying drawings.

FIG. 1 is a rear, plan view of a sheet of printable media in accordance with a preferred embodiment of a present invention.

FIG. 2 is a rear, plan view of a sheet of printable media in accordance with a preferred embodiment of a present invention.

FIG. 3 is a partial rear, plan view of a sheet of printable media in accordance with a preferred embodiment of a present invention.

FIG. 4 is a rear, plan view of a sheet of printable media in accordance with a preferred embodiment of a present invention.

FIGS. 5A to 5F are front, plan views of sheets of the printable media illustrated in FIG. 4 with respective portions of the image for a two-dimensional multi-sheet assembly printed thereon.

FIG. 6 is a front, plan view showing the sheets of printable media illustrated in FIGS. 5A to 5F in a completed multi-sheet assembly.

FIG. 7 is a rear, plan view of a sheet of printable media in accordance with a preferred embodiment of a present invention.

FIG. 8 is a rear, plan view of a sheet of printable media in accordance with a preferred embodiment of a present invention.

FIG. 9 is a rear, plan view of a sheet of printable media in accordance with a preferred embodiment of a present invention.

FIG. 10 is a rear, plan view of a sheet of printable media in accordance with a preferred embodiment of a present invention.

### DETAILED DESCRIPTION OF THE PREFERRED EMBODIMENTS

The following is a detailed description of the best presently known modes of carrying out the inventions. This description is not to be taken in a limiting sense, but is made merely for the purpose of illustrating the general principles of the inventions. The scope of the inventions is defined solely by the claims.

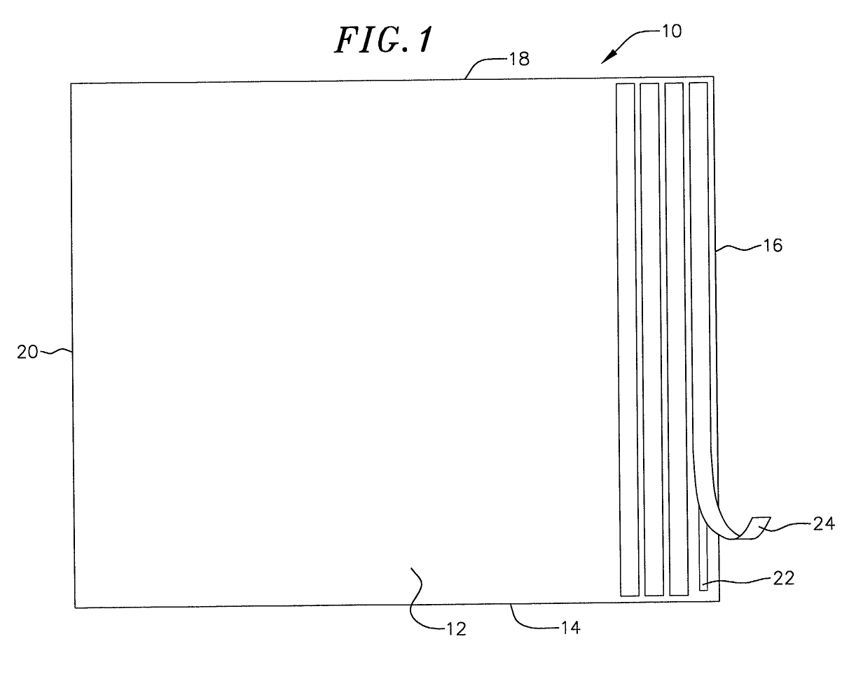

As illustrated for example in FIG. 1, a sheet of printable media 10 in accordance with one embodiment of a present invention includes a base sheet 12 with side edges 14, 16, 18 and 20, a plurality of adhesive strips 22 and a corresponding plurality of release liners 24 covering the adhesive strips. The adhesive strips 22 and release liners 24 are positioned on the rear side of the base sheet 12 in the exemplary embodiment. One or more of the release liners 24 may be removed so that one or more of the adhesive strips 22 can be used to secure the sheet of printable media 10 to, for example, another sheet of printable media to form a multi-sheet assembly. Such an arrangement allows the user to selectively determine how wide the overall (or “effective”) adhesive area will be by simply removing the appropriate number of release liners 24. Removal of only the release liner 24 closest to the side edge 16 will result in a relatively thin adhesive area, while removal of all of the release liners will result in a relatively wide adhesive area.

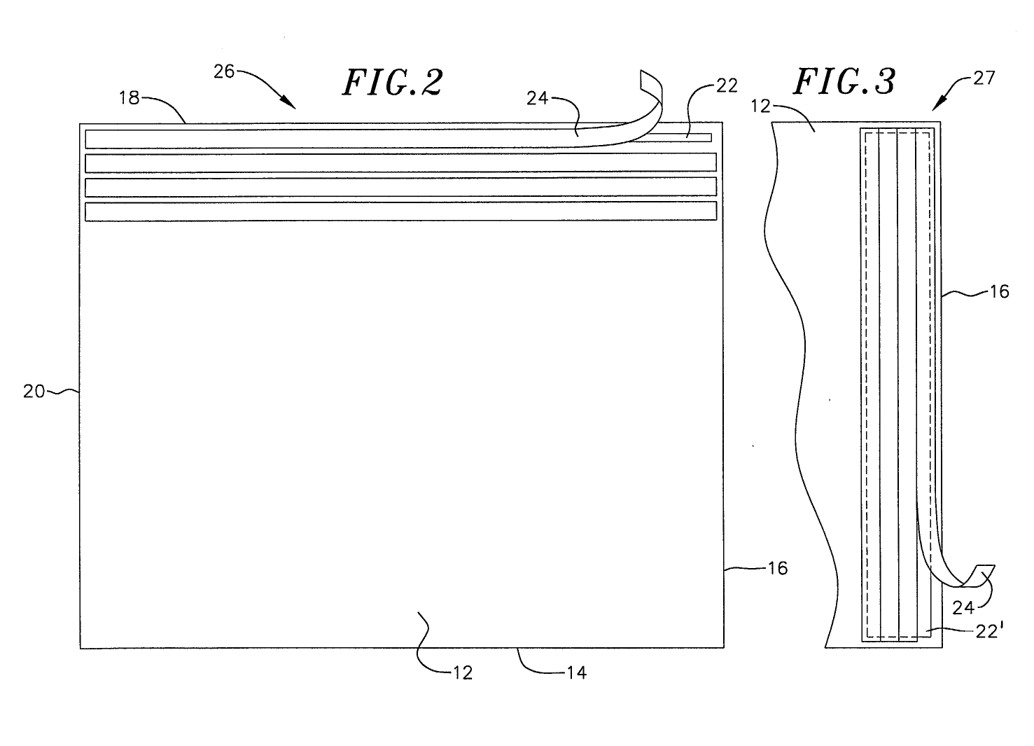

The exemplary embodiments illustrated in FIGS. 2-10 include many components that are essentially identical to, or are slight variations of, those of the exemplary embodiment illustrated in the FIG. 1. Such components, which are shown by the same reference numerals in each of the FIGURES, are described in the following paragraphs and the specific features of the embodiments illustrated in FIGS. 2-10 are described thereafter.

Turning first to the base sheet, the base sheet 12 in the exemplary embodiments may be formed from any material that is suitable for the intended multi-sheet assembly and for the printing device used to form the image. Such material includes, but is not limited to, standard paper, photo-grade and other heavy weight paper, transparent and translucent plastic, cardstock and foil. With respect to size, the base sheet 12 is preferably a letter size (8½×11 inches) sheet. Legal size (8½×14 inches) and A4 size (210 mm×297 mm) are other examples of sheets that typical printers can accommodate. Even larger sheets may be used in those instances where the intended printing device can accommodate them.

Pressure sensitive adhesives, such as permanent and/or removable acrylic emulsion adhesives, are the preferred adhesives for the exemplary embodiments. Other exemplary adhesives include water and chemical activated adhesives, which may eliminate the need for a release liner, as well as any other adhesive that is suitable for an intended application. With respect to the size of the adhesive strips 22, the adhesive strips are preferably uniform in size (about ⅜ inch wide) with about 1/32 inch therebetween. Nevertheless, the width and/or spacing may be varied if desired. The overall width of the adhesive region defined by the strips should be between about ½ inch and about 2 inches. The length of the adhesive strips 22 should closely correspond to the length of the corresponding side edge, such as side edge 16 in FIG. 1.

The adhesive strip 22 (or portion of the adhesive strip 22′ described below with reference to FIG. 3) that is closest to the corresponding side edge should also be no more than about 1/32 inch from the side edge in preferred implementations. This will reduce the visibility of the seams between adjacent sheets in the multi-sheet assembly. A somewhat greater distance is shown in the FIGURES so that the various elements of the exemplary embodiments can be more readily distinguished from one another. Additionally, although the strips in the exemplary embodiments are continuous and generally rectangular, strips which have some discontinuities and/or irregular shapes may be employed.

Suitable material for the release liners 24 includes, but is not limited to, release paper with a siliconized release coating applied to it. The release liners 24 may be either slightly spaced apart, as shown in FIG. 1, or closely adjacent to one another. Closely adjacent release liners may be formed from a single piece of material that is die cut after assembly into a number of separate release liners.

The adhesive strips 22 and release liners 24 in the exemplary sheet of printable media 10 illustrated in FIG. 1 are positioned adjacent to one of the short edges of the base sheet 12. This arrangement allows successive sheets of printable media 10 to be assembled short edge to short edge. Alternatively, as illustrated for example in FIG. 2, a sheet of printable media 26 may be configured with the adhesive strips 22 and release liners 24 adjacent to one of the long edges of the base sheet 12.

As illustrated for example in FIG. 3, the plurality of adhesive strips 22 in the sheet of printable media 10 illustrated in FIG. 1 has been replaced by a single, relatively large adhesive strip 22′ in the exemplary sheet of printable media 27. A plurality of release liners 24 cover the adhesive strip 22′. Here too, the effective width of the adhesive strip 22′ may varied by varying the number release liners 24 that are removed. The release liners 24 in the exemplary sheet 27 should be very close together in order to prevent the adhesive from making unintended contact with other sheets of printable media during storage and with printer rollers and other printer components during printing. The adhesive strips 22 in the exemplary sheet 26 (FIG. 2) may also be replaced by the relatively large adhesive strip 22′.

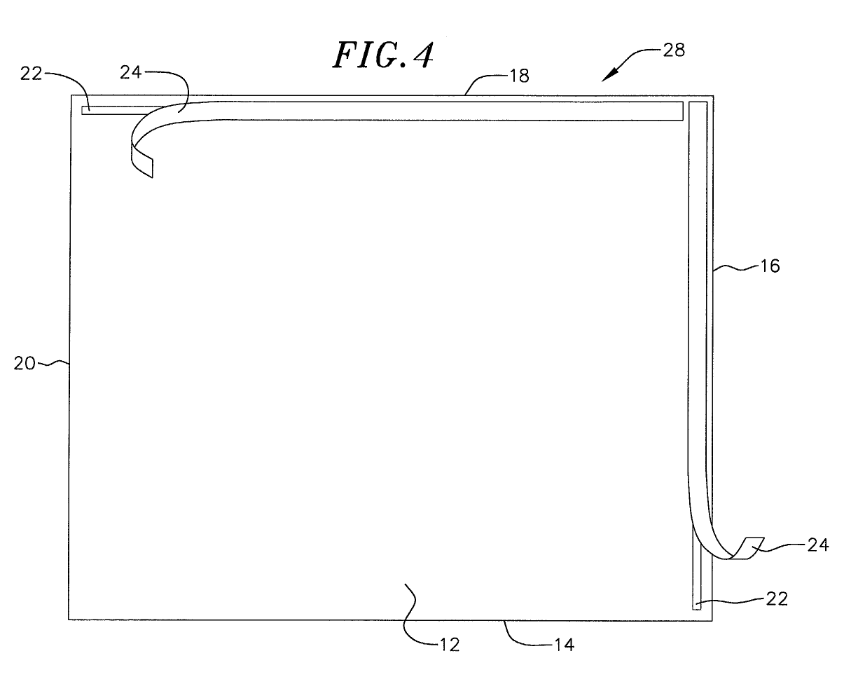

As illustrated for example in FIG. 4, a sheet of printable media 28 which is especially useful in two-dimensional multi-sheet assemblies includes adhesive strips 22 that are positioned adjacent to at least two intersecting side edges (side edges 16 and 18 in the exemplary embodiment). Corresponding release liners 24 are provided in those instances where pressure sensitive adhesive is employed. The release liners 24 may be omitted where water or chemical activated adhesive is employed. The sheet 28 may also be used to form a one-dimensional multi-sheet assembly if desired. Here, one of the release liners 24 will simply be left in place or, when water or chemically activated adhesive is used, one strip of adhesive will not be activated. Some of the adhesive strips 22 may also go unused in a two-dimensional multi-sheet assembly, as is described below.

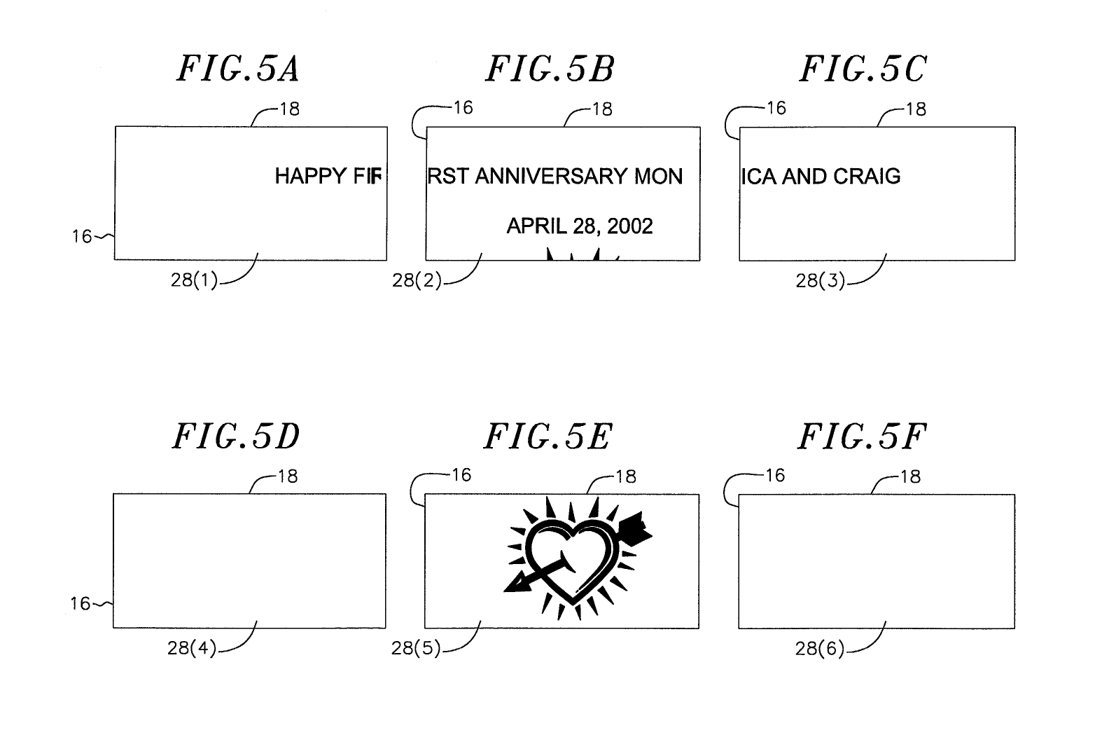

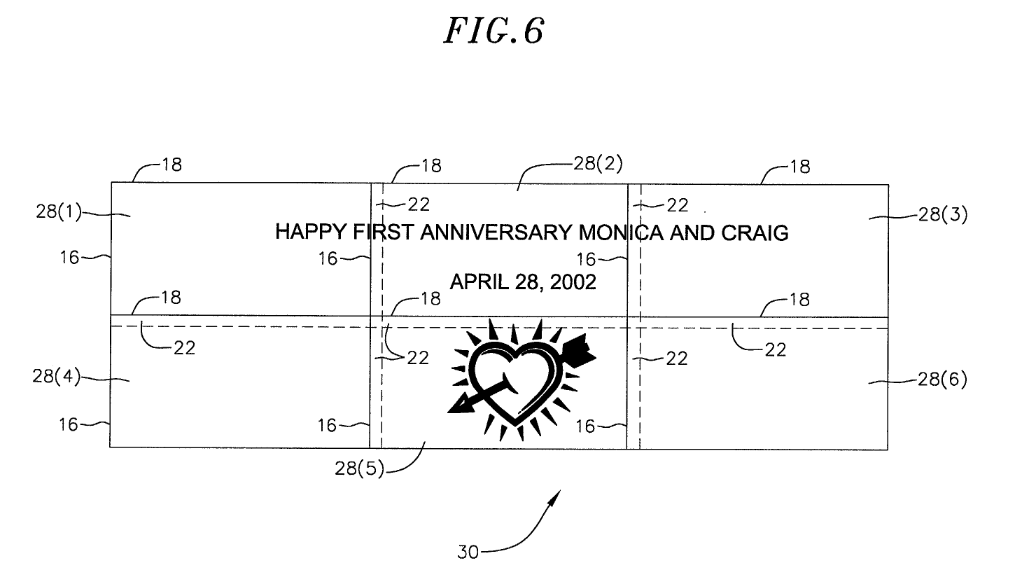

The exemplary series of six sheets 28(1)-28(6) illustrated in FIGS. 5A to 5F may be used to form the multi-sheet assembly 30 illustrated in FIG. 6. The multi-sheet assembly 30 includes two rows of three sheets over which the overall image is divided. The image is preferably printed such that small portions of the image are repeated near the side edges that will ultimately overlap. [Note the letter “R” on sheets 28(1) and 28(2).] As best seen in FIG. 6, adhesive strips 22 on two intersecting side edges will provide all of the adhesive necessary to form a two-dimensional multi-sheet assembly. [Only those adhesive strips 22 which are necessary to form the multi-sheet assembly 30 are shown in FIG. 6.] None of the adhesive strips 22 on sheet 28(1) in upper row of the exemplary embodiment are used, while the adhesive strips associated with side edges 16 are used in sheets 28(2) and 28(3). Turning to the lower row, only the adhesive strip 22 associated with side edge 18 is used in sheet 28(4), while both of the adhesive strips are used in sheets 28(5) and 28(6).

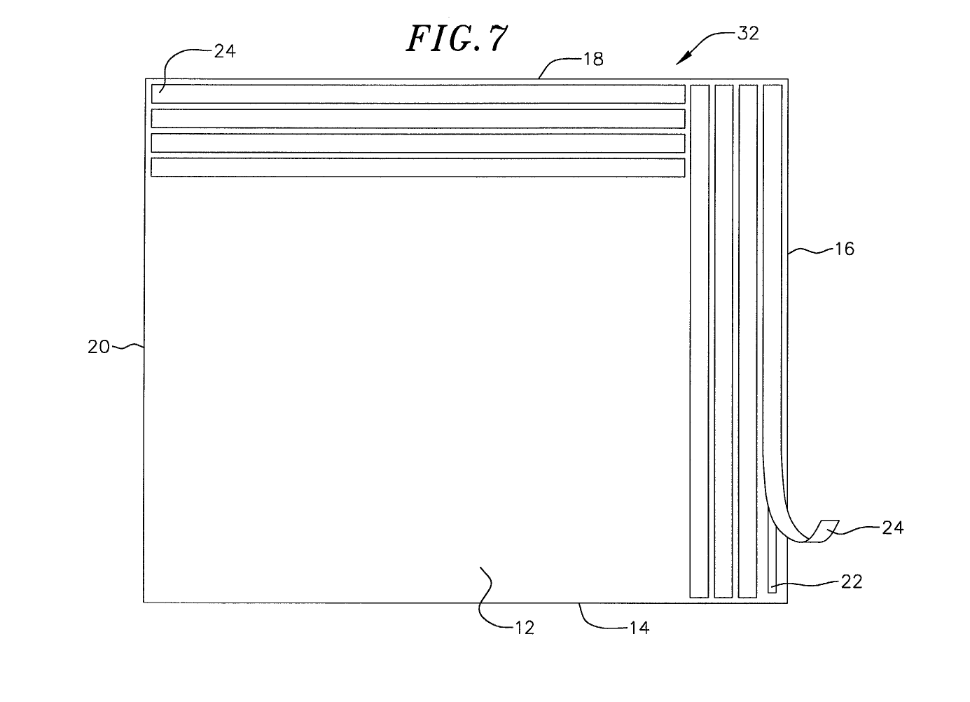

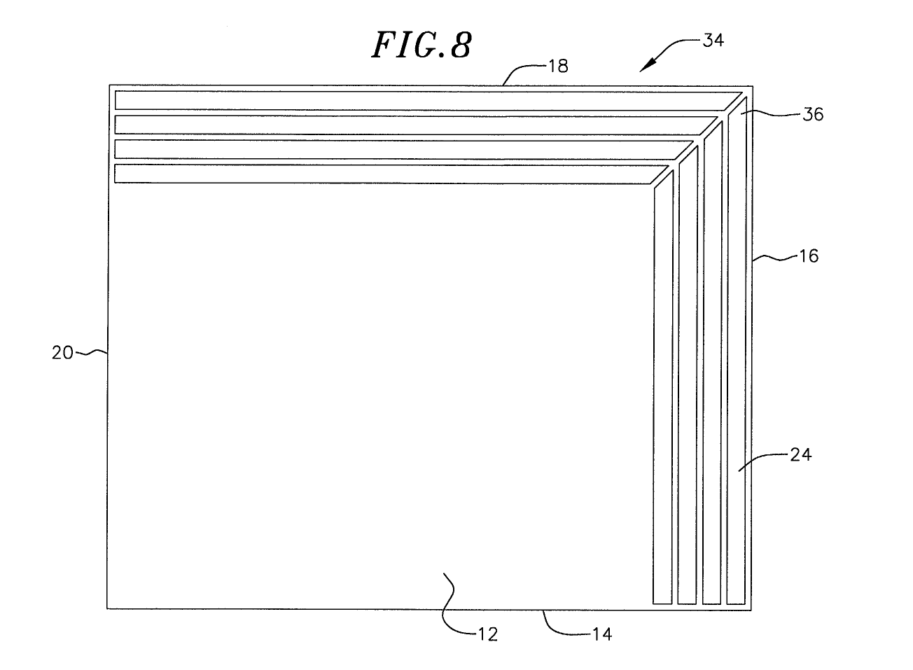

The number and/or size of the adhesive strips and corresponding release liners may also be varied in the manner described above with reference to FIGS. 1-3 in those instances where adhesive is positioned adjacent to two or more intersecting side edges. Referring first to FIG. 7, an exemplary sheet of printable media 32 includes four adhesive strips 22 and four release liners 24 adjacent to the side edge 16 and another four adhesive strips and release liners adjacent to the side edge 18. Such an arrangement allows the user to selectively determine the effective size of the adhesive areas in the manner described above with reference to FIGS. 1-3.

The exemplary sheet of printable media 34 illustrated in FIG. 8 also includes four adhesive strips 22 (not visible) and four release liners 24 adjacent to the side edge 16, and another four adhesive strips and release liners adjacent to the side edge 18. Here, however, the release liners 24 include mitered ends 36 at the corner where side edges 16 and 18 meet. The mitered ends 36 prevent the formation of adhesive gaps in those instances where less than all of the release liners are removed. If, for example, the release liner 24 closest to the side edge 16 and the release liner closest to the side edge 18 were both removed, a strip of adhesive extending essentially across each of the side edges to their common corner would be exposed for use. Similarly, if the outermost release liner 24 on only one side edge was removed, the underlying strip of adhesive 22 would extend from one end of the side edge to the other.

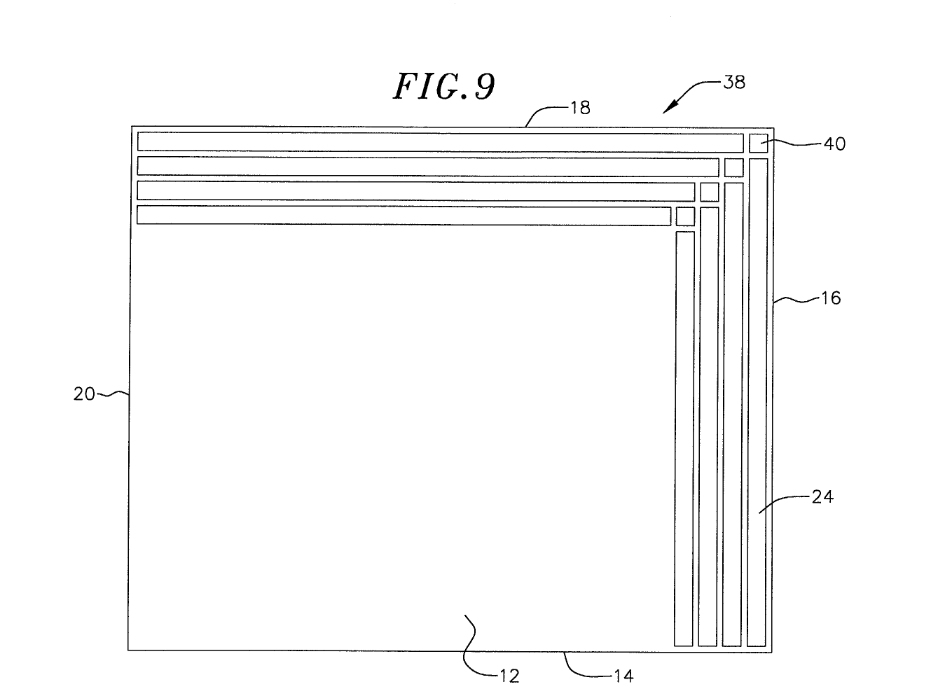

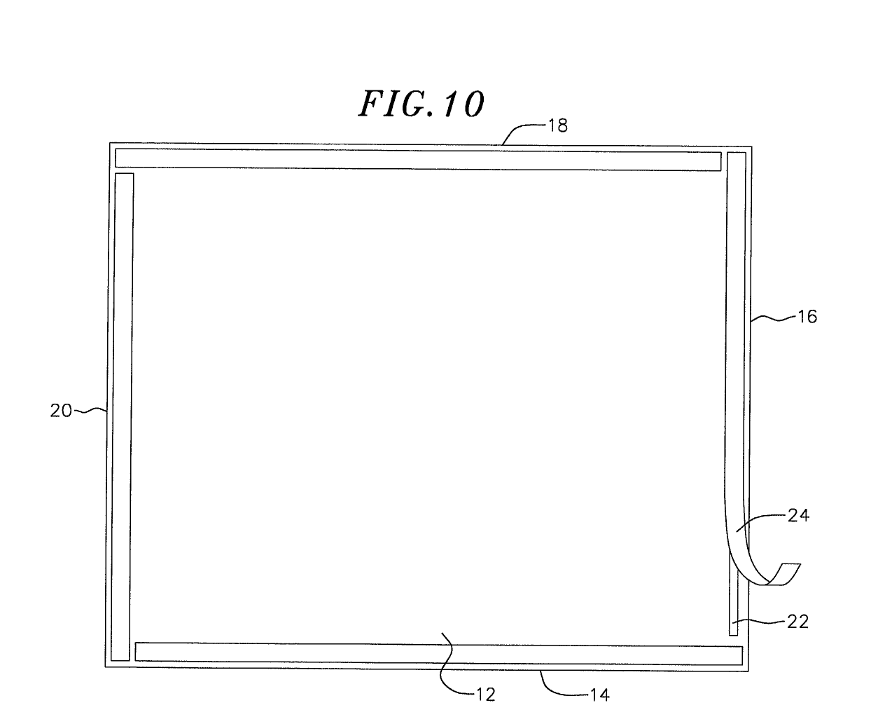

Turning to the exemplary sheet of printable media 38 illustrated in FIG. 9, similar results may be obtained through the used of release liner corner members 40. One corner member 40 is associated with each intersecting pair of release liners 24. Removal of the release liners 24 closest to the side edges 16 and 18 and the corresponding corner member 40 would expose a strip of adhesive extending essentially across each of the side edges to their common corner. Similarly, if one of the release liners 24 closest to a side edge and the corresponding corner member 40 was removed, a strip of adhesive 22 would be exposed from one end of the side edge to the other.

It should also be noted that a pair of relatively large adhesive strips and a plurality of release liners that are very close to one another, similar to the adhesive strip 22′ and the release liners 24 illustrated in FIG. 3, may be employed in the embodiments illustrated in FIGS. 7-9. Additionally, continuous L-shaped adhesive strip(s) that extend along two adjacent side edges and/or continuous L-shaped release liner(s) may be also employed.

Although the present inventions have been described in terms of the preferred embodiment above, numerous modifications and/or additions to the above-described preferred embodiments would be readily apparent to one skilled in the art. By way of example, but not limitation, sheets having adhesive along three or four of the edges may also be employed. The sheet of printable media 42 illustrated in FIG. 10, for example, includes adhesive strips 22 and release liners 24 along each of the four side edges 14-20. It is intended that the scope of the present inventions extends to all such modifications and/or additions.

I claim:

1. Printable media, comprising:
a sheet defining a front side, a rear side and a plurality of side edges;
at least one strip of adhesive material on one of the front and rear sides of the sheet adjacent to a first one of the plurality of side edges; and
a plurality of liners positioned over the at least one strip of adhesive material.

2. Printable media as claimed in claim 1, wherein the sheet comprises a paper sheet.

3. Printable media as claimed in claim 1, wherein the sheet comprises an 8½ inch×11 inch sheet.

4. Printable media as claimed in claim 1, wherein the adhesive material comprises pressure sensitive adhesive.

5. Printable media as claimed in claim 1, wherein a second one of the side edges is parallel to the first one of the side edges and the at least one strip of adhesive material extends only partially from the first one of the side edges to the second one of the side edges.

6. Printable media as claimed in claim 1, wherein the at least one strip of adhesive material comprises a plurality of strips of adhesive material and the plurality of liners are respectively positioned over the plurality of strips of adhesive material.

7. Printable media as claimed in claim 1, wherein the at least one strip of adhesive material comprises a single strip of adhesive material defining a width, each of the plurality of liners define respective widths that are less than the width of the single strip of adhesive material, and the plurality of liners are positioned closely adjacent to one another over the single strip of adhesive material.

8. Printable media as claimed in claim 1, wherein the side edges define longitudinal ends and the adhesive material extends substantially from one longitudinal end of the one of the plurality of side edges to the other longitudinal end of the one of the plurality of side edges.

9. Printable media, comprising:
a sheet defining a front side, a rear side and at least first and second intersecting side edges, each of the first and second side edges defining opposing longitudinal ends, one of longitudinal ends of each of the first and second side edges defining a common longitudinal end;
a first strip of adhesive material on one of the front and rear sides of the sheet adjacent to the first side edge and extending substantially from one longitudinal end of the first side edge to the other longitudinal end of the first side edge; and
a second strip of adhesive material on the one of the front and rear sides of the sheet adjacent to the second side edge and extending substantially from one longitudinal end of the second side edge to the other longitudinal end of the second side edge.

10. Printable media as claimed in claim 9, wherein the sheet comprises a paper sheet.

11. Printable media as claimed in claim 9, wherein the sheet comprises an 8½ inch×11 inch sheet.

12. Printable media as claimed in claim 9, wherein the adhesive material comprises pressure sensitive adhesive.

13. Printable media as claimed in claim 9, wherein the first strip of adhesive material comprises a plurality of first strips of adhesive material, the printable media further comprising:
a plurality of first liners respectively positioned over the plurality of first strips of adhesive material.

14. Printable media as claimed in claim 13, wherein the second strip of adhesive material comprises a plurality of second strips of adhesive material, the printable media further comprising:
a plurality of second liners respectively positioned over the plurality of second strips of adhesive material.

15. Printable media as claimed in claim 9, further comprising:
first and second liners respectively covering the first and second strips of adhesive material.

16. Printable media as claimed in claim 15, wherein the first and second liners include mitered ends adjacent to the common longitudinal end of the first and second side edges.

17. Printable media as claimed in claim 15, further comprising:
a liner corner member adjacent to the common longitudinal end of the first and second side edges.

18. Printable media as claimed in claim 9, wherein the first strip of adhesive material defines a width, the first liner comprises a plurality of first liners defining respective widths that are less than the width of the first strip of adhesive material, and the plurality of first liners are positioned closely adjacent to one another over the first strip of adhesive material.

19. Printable media as claimed in claim 18, wherein the second strip of adhesive material defines a width, the second liner comprises a plurality of second liners defining respective widths that are less than the width of the second strip of adhesive material, and the plurality of second liners are positioned closely adjacent to one another over the second strip of adhesive material.

20. Printable media, comprising:
a sheet defining a front side, a rear side, first and second horizontally extending side edges, and first and second vertically extending side edges, each of the side edges defining opposing longitudinal ends;
a horizontally extending strip of pressure sensitive adhesive on the rear side of the sheet adjacent to the first horizontally extending side edge and extending substantially from one longitudinal end of the first horizontally extending side edge to the other longitudinal end of the first horizontally extending side edge;
a vertically extending strip of pressure sensitive adhesive on the rear side of the sheet adjacent to the first vertically extending side edge and extending substantially from one longitudinal end of the first vertically extending side edge to the other longitudinal end of the first vertically extending side edge;
a plurality of closely spaced horizontally extending release liners together covering at least a substantial majority of the horizontally extending strip of pressure sensitive adhesive; and
a plurality of closely spaced vertically extending release liners together covering at least a substantial majority of the vertically extending strip of pressure sensitive adhesive.
